(19) United States
(12) Patent Application Publication
(10) Pub. No.: US 2009/0193985 A1
(43) Pub. Date: Aug. 6, 2009

(54) Control element for a press and press with a control element

(76) Inventors: Jurgen Bussert, Igensdorf (DE); Thilo Sporbert, Schnaittach (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/319,520

(22) Filed: Jan. 8, 2009

(30) Foreign Application Priority Data
Jan. 10, 2008 (EP) 08000387.4

(51) Int. Cl. B30B 5/00; B30B 15/16

(52) U.S. Cl. 100/257; 100/48

(57) ABSTRACT

A control element for a press as well as a press with such a control element is described. The control element is used to position an upper tool of the press at, on or in a work piece to be processed, with the control element featuring at least one actuator by which an opposing moment or an opposing force is created on an operating hand of an operator, with the opposing moment or the opposing force being related to a current slide force by means of which the upper tool acts on the work piece. The press further includes a control unit for determining the current slide force, so that the control unit on the basis of the slide force determined outputs a control command to the control element by which the actuator of the control element is activated.

### CROSS REFERENCE TO RELATED APPLICATIONS

This application claims priority of European Patent Office application No. 08000387.4 EP filed Jan. 10, 2008, which is incorporated by reference herein in its entirety.

### FIELD OF INVENTION

The invention relates to a control element for a press as well as to a press with such a control element.

### BACKGROUND OF INVENTION

With known presses, especially servo presses, a hand wheel is mostly used as a control element when moving in new tools and setting up new products in a press. With such a hand wheel the operator can position the slide of the press very precisely, on a sheet of metal for example.

With the hand wheel the operator can move the slide in minimal steps when the tool is being adapted and in doing so position it every exactly. Furthermore he can also undo the movement of the slide or correct it in order to ensure an optimum setup especially of the new tool. This makes incorporation of new tools a simple matter for the operator.

When the press acts on the work piece a transformation process takes place. The operator must be able to assess the result of the transformation process and for this purpose requires feedback about press forces currently occurring. In particular it is important for the operator to know the moments or forces acting through the slide on the work piece.

This especially enables the operator to precisely control and speed up the incorporation of the new tool.

Previously the operator could read off the press forces and moments currently occurring from the machine operating panel of the press. The operator then includes this information obtained visually into his actuation of the hand wheel for control of the press.

### SUMMARY OF INVENTION

An object of the invention is to specify an improved control element for a press, which is especially designed to enable the precision and the speed of setting up new press tools to be improved.

The problem is resolved by a control element for a press by means of which an upper tool of the press is able to be positioned at, on or in a work piece to be processed, with the control element featuring at least one actuator, by means of which an opposing moment or opposing force is able to be created on an operating hand of an operator, with the opposing moment or the opposing force being related to a current force by means of which the upper tool acts on the work piece.

The control element is given the capability for sensor feedback to the operating hand of the operator, by the said force of the upper tool being mapped onto an opposing moment or onto an opposing force of the control element. Thus the machine operator receives sensory feedback to his operating hand by means of which he can introduce a new tool intuitively and significantly more quickly than previously. The setup process of the new tool part has thus been made “tactile”. In this case errors especially arising from misinterpretation are reduced, since for example the reading off of forces from the machine operating panel is dispensed with. The operator can react directly to the opposing moment or the opposing force and can observe the result of the action.

In an advantageous embodiment the actuator includes a stepping motor.

Stepping motors for creating the opposing moment or the opposing force are nowadays available even in small designs, so that these can be accommodated comfortably in a compact hand control element for a press.

As an alternative or in addition the actuator can also include a so-called rumble motor by means of which at least one vibration pattern is created.

These types of rumble motor are known for example from mobile telephones, in which instead of a ring tone or in addition to this, the mobile telephone is excited into vibrations in order to indicate an incoming call or other data to the user. Different vibration patterns can indicate different events to the user of the mobile telephone here. When transferred to the press application the vibration pattern or vibration patterns can be tailored to the current slide force, so that the vibration pattern is a measure for the said force of the upper tool.

The vibration pattern is consequently related in this case to the current slide force.

Furthermore the actuator can include a spring of which the tension is related to the force of the upper tool.

Thus the spring force operates here as an opposing moment or opposing force on the operating hand of the operator.

The control element is embodied especially advantageously as a hand wheel.

Further advantageous embodiments can be found in further dependent claims.

The invention further leads to a press, comprising at least one control element as stated above, as well as a control unit connected to the control element for determination of the current force with which the upper tool acts on the work piece, and for activation of the control element with a control command, based on the determined current force of the upper tool, so that the actuator activated with the control command generates the opposing moment or the opposing force on the control hand.

### BRIEF DESCRIPTION OF THE DRAWINGS

An exemplary embodiment of the invention is shown in greater detail below with reference to two figures.

The figures are as follows:

FIG. 1 a schematic diagram of a press with a element, and

FIG. 2 a schematic sectional diagram through a press with a control element.

### DETAILED DESCRIPTION OF INVENTION

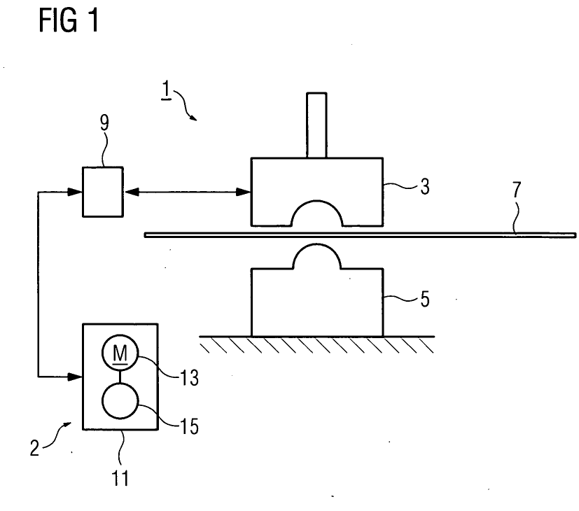

FIG. 1 shows a press 1, comprising an upper tool 3, driven by a press slide not shown in any greater detail, as well as a lower tool 5.

A metal work piece 7, which is to be pressed by means of the upper tool 3 into a desired form, is introduced for example between the upper tool 3 and the lower tool 5.

For setting up the press 1, an operator of the press 1 has a hand wheel 11 available to him as a control element. This hand wheel 11 can for example include a rotary switch 15 by means of which the press slide can be moved in very small steps. As soon as the upper tool 3 hits the metal work piece 7 supported on a holder, a press force is exerted on this metal work piece 7. The press force is determined by means of a control unit 9. From this current press force determined the control unit 9 forms a control command for activation of the hand wheel 11. The hand wheel 11 comprises an actuator 13, for example a stepping motor, by means of which an opposing moment or an opposing force is generated on an operating hand of the press operator.

This opposing moment or this opposing force on the control hand of the press operator is related to the press force of the upper tool. The operator thus obtains a sensory feedback via this actually occurring force.

This enables the press operator to perform the setting up of the press 1 intuitively and very precisely as well as very quickly, since he “has a feeling” for how he must move the tool.

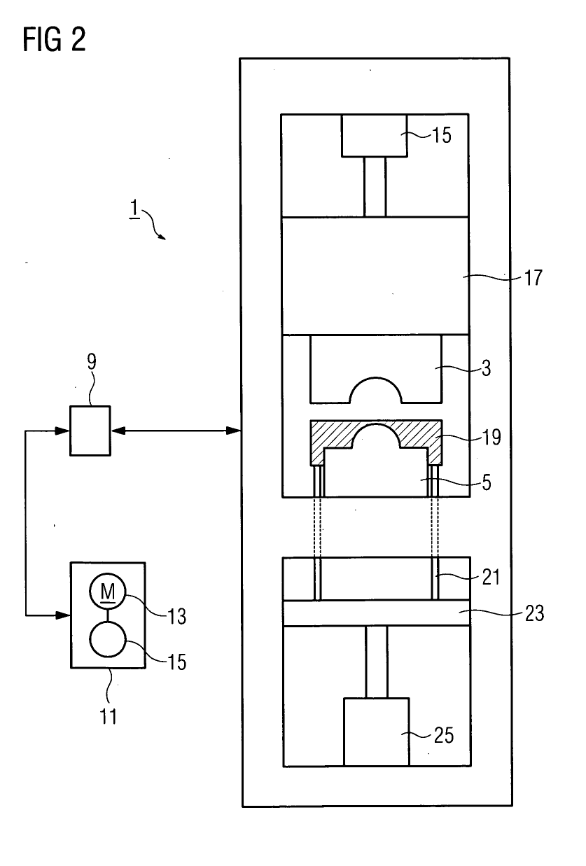

FIG. 2 shows a schematic sectional diagram through a press with a control element.

The press 1 comprises a slide cylinder 15 for driving a press slide 17.

Connected to the press slide 17 is an upper tool 3 for forming a sheet metal work piece 7. The sheet metal work piece 7 is supported on a sheet holder 19 which is movable in relation to a lower tool 5. The lower tool 5 is connected to a press table.

One or more push rods 21, driven by a cushion cylinder 25 via a tensile cushion plate 23, press the plate holder 19 upwards against the downwards-directed force of the upper tool 3.

The control unit 9 and the hand wheel 11 with the actuator 13 correspond to the corresponding elements in FIG. 1.

1.-9. (canceled)

10. A control element for positioning an upper tool of a press at, on or in a work piece to be processed, comprising:
an actuator for generating an opposing moment or an opposing force on an operating hand of an operator, wherein the opposing moment or the opposing force is related to a current force by which the upper tool acts on the work piece.

11. The control element as claimed in claim 10, wherein the actuator includes a stepping motor.

12. The control element as claimed in claim 10, wherein the actuator includes a rumble motor for creating at least one vibration pattern.

13. The control element as claimed in claim 11, wherein the actuator includes a rumble motor for creating at least one vibration pattern.

14. The control element as claimed in claim 12, wherein the vibration pattern is related to the current force by which the upper tool acts on the work piece.

15. The control element as claimed in claim 13, wherein the vibration pattern is related to the current force by which the upper tool acts on the work piece.

16. The control element as claimed in claim 10, wherein the actuator includes a spring of which the tension is related to the current force by which the upper tool acts on the work piece.

17. The control element as claimed in claim 10, wherein the control element is a hand wheel.

18. The control element as claimed in claim 10, wherein the opposing moment or the opposing force is directly proportional to the current force by which the upper tool acts on the work piece.

19. The control element as claimed in claim 10, wherein the opposing moment or the opposing force is determined on the basis of a predetermined characteristic curve in which the opposing moment or the opposing force is represented as a function of the current force, with the current force being that force by which the upper tool acts on the work piece.

20. A press, comprising:
a control element for positioning an upper tool of the press at, on or in a work piece to be processed, the control element having an actuator for generating an opposing moment or an opposing force on an operating hand of an operator, wherein the opposing moment or the opposing force is related to a current force by which the upper tool acts on the work piece; and
a control unit connected to the control element for determining the current force by which the upper tool acts on the work piece and for activating the control element with a control command based on the determined current force, so that the actuator activated with the control command creates the opposing moment or the opposing force on the operator hand.

21. The press as claimed in claim 20, wherein the actuator of the control element includes a stepping motor.

22. The press as claimed in claim 20, wherein the actuator of the control element includes a rumble motor for creating at least one vibration pattern.

23. The press as claimed in claim 22, wherein the vibration pattern is related to the current force by which the upper tool acts on the work piece.

24. The press as claimed in claim 20, wherein the actuator of the control element includes a spring of which the tension is related to the current force by which the upper tool acts on the work piece.

25. The press as claimed in claim 20, wherein the control element is a hand wheel.

26. The press as claimed in claim 20, wherein the opposing moment or the opposing force is directly proportional to the current force by which the upper tool acts on the work piece.

27. The press as claimed in claim 20, wherein the opposing moment or the opposing force is determined on the basis of a predetermined characteristic curve in which the opposing moment or the opposing force is represented as a function of the current force, with the current force being that force by which the upper tool acts on the work piece.
